(19) United States
(12) Patent Application Publication
(10) Pub. No.: US 2018/0200913 A1
(43) Pub. Date: Jul. 19, 2018

(54) CUTTING TOOL WITH ADJUSTABLE CUTTING BLADE

(71) Applicant: Charlie ZHANG, Oak Brook, IL (US)

(72) Inventor: Charlie ZHANG, Oak Brook, IL (US)

(21) Appl. No.: 15/685,325

(22) Filed: Aug. 24, 2017

Related U.S. Application Data
(60) Provisional application No. 62/446,700, filed on Jan. 16, 2017.

(51) Int. Cl. B26F 1/40; B26F 1/38; B26D 5/10; B26D 7/01

(52) U.S. Cl. CPC B26F 1/40; B26F 1/38; B26F 1/3806; B26D 7/01; B26D 5/10

(57) ABSTRACT

A cutting tool for cutting materials with a straight perpendicular cut, an angled cut, a length-wise cut, and/or a notched cut. The cutting tool including a base, a pair of supports, a cam pivotally connected to the pair of supports, and a blade holder and a blade positioned between the cam and the base, where the blade holder and the blade are slideable from a first cutting position to a second cutting position for cutting notches and other shapes into the flooring materials.

### CROSS REFERENCE TO RELATED APPLICATIONS

This application claims the benefit of U.S. Provisional Patent Application Ser. No. 62/446,700, filed on 16 Jan. 2017. The co-pending Provisional patent application is hereby incorporated by reference herein in its entirety and is made a part hereof, including but not limited to those portions which specifically appear hereinafter.

### BACKGROUND OF THE INVENTION

### Field of the Invention

This invention relates to a cutting tool for cutting sheets of material, such as, for example, flooring. More specifically, this invention relates to a cutting tool including a base, a pair of supports, a cam pivotally connected to the pair of supports, and a blade holder and a blade positioned between the cam and the base, where the blade holder and the blade are slideable from a first cutting position to a second cutting position for cutting notches and other shapes into the flooring materials.

### Discussion of Related Art

Certain building materials, such as, for example, flooring materials and siding, are provided as sheets or planks of various dimensions. When used on a job site, the sheets or planks must be customized to meet the specific requirements of the job site. For example, the sheets or planks must be cut to fit around edges or corners of a room and/or around fixtures. Various tools are currently used to cut sheets of building materials, but most are bulky, heavy, require power to be operated, produce large amounts of dust during the cutting process, and/or result in uneven or splintered cuts. Other known tools require multiple sized blades to cut various length and/or to cut only portions of the building materials.

There is a need or a desire for an improved cutting tool for cutting notches and other shapes into flooring. There is a need or a desire for a portable, non-power operated cutting tool able to cut sheets of building materials in a predictable and straight fashion without splintering, cracking or similar problems and providing fast, dust-free cutting.

### SUMMARY OF THE INVENTION

The present invention provides a portable, non-power operated cutting tool for cutting flooring materials in a straight fashion without splintering or cracking. The present invention also provides a cutting tool for cutting notches and other shapes into the flooring materials.

According to an embodiment of this invention, the cutting tool includes a base and a pair of supports connected to the base. A cam with an increasing radius is positioned over a portion of the base and rotatably connected between the pair of supports. A blade holder, with a blade, is engaged with the cam and is positioned over the base. A handle can be connected to the cam to assist in rotating the cam. The blade holder and the blade are moveable between an open position and a closed position, cut position, by pivoting the cam. In the open position, the cam contacts the blade holder at a relatively small radius, as the cam rotates, the blade holder contacts the cam at a gradually increasing radius until the blade holder and the blade are in a closed position to cut the material.

In a preferred embodiment, the blade holder and/or the blade are slideable generally perpendicularly relative to at least one of the base and relative to the pair of supports allowing the blade to be positioned either wholly between the pair of supports or with a portion of the blade between the supports and a portion of the blade outside one of the supports. This slideable arrangement allows a user to either cut an entire width of material positioned between the supports or a portion of the width of the material positioned between the supports. This slideable arrangement may be useful for cutting notches or other shapes into the flooring material. In a preferred embodiment, at least one of the pair of supports includes an opening to allow the blade holder and the blade to pass through. In a preferred embodiment, at least one of the blade holder, blade or the supports include a locking mechanism for securing a position of the blade holder and/or blade relative to at least one of the pair of supports.

According to an embodiment, as the blade holder and blade travel from the open position to the closed position, the blade holder is maintained in a generally straight path by a guide pillar or a plurality of guide pillars. In a preferred embodiment, a spring surrounds the guide pillar. The spring biases the blade holder in the open position and as the blade holder travels downward, the spring is compressed to further urge a uniform cut of the blade through the material.

According to an embodiment of this invention, the base defines a support surface. The support surface preferably includes a guide rail for aligning the material to be cut. The base may further include at least one support member, for example a leg and/or a foot for supporting the base before and during cutting. In an embodiment, the leg and/or the foot are adjustable to compensate for an uneven ground surface.

### BRIEF DESCRIPTION OF THE DRAWINGS

These and other objects and features of this invention will be better understood from the following detailed description taken in conjunction with the drawings, wherein:

FIG. 1 is a perspective view of a cutting tool according to one embodiment of this invention with a blade positioned between a pair of supports.

FIG. 2 is another perspective view of the cutting tool shown in FIG. 1.

FIG. 3 is a front view of the cutting tool shown in FIG. 1 with a side cover removed.

FIG. 4 is a top view of the cutting tool shown in FIG. 1.

FIG. 5 is a left side view of the cutting tool shown in FIG. 1.

FIG. 6 is a right side view of the cutting tool shown in FIG. 1.

FIG. 7 is a perspective view of the cutting tool shown in FIG. 1 with a portion of the blade positioned outside of one of the pair of supports.

FIG. 8 is another perspective view of the cutting tool shown in FIG. 7.

FIG. 9 is a front view of the cutting tool shown in FIG. 7.

FIG. 10 is a top view of the cutting tool shown in FIG. 7.

FIG. 11 is a left side view of the cutting tool shown in FIG. 7.

FIG. 12 is a right side view of the cutting tool shown in FIG. 7.

FIG. 13 is a perspective view of a blade holder system of this invention without the other components of the cutting tool.

FIG. 14 is a front view of the blade holder system shown in FIG. 13.

FIG. 15 is a side view of the blade holder system shown in FIG. 13.

### DESCRIPTION OF THE INVENTION

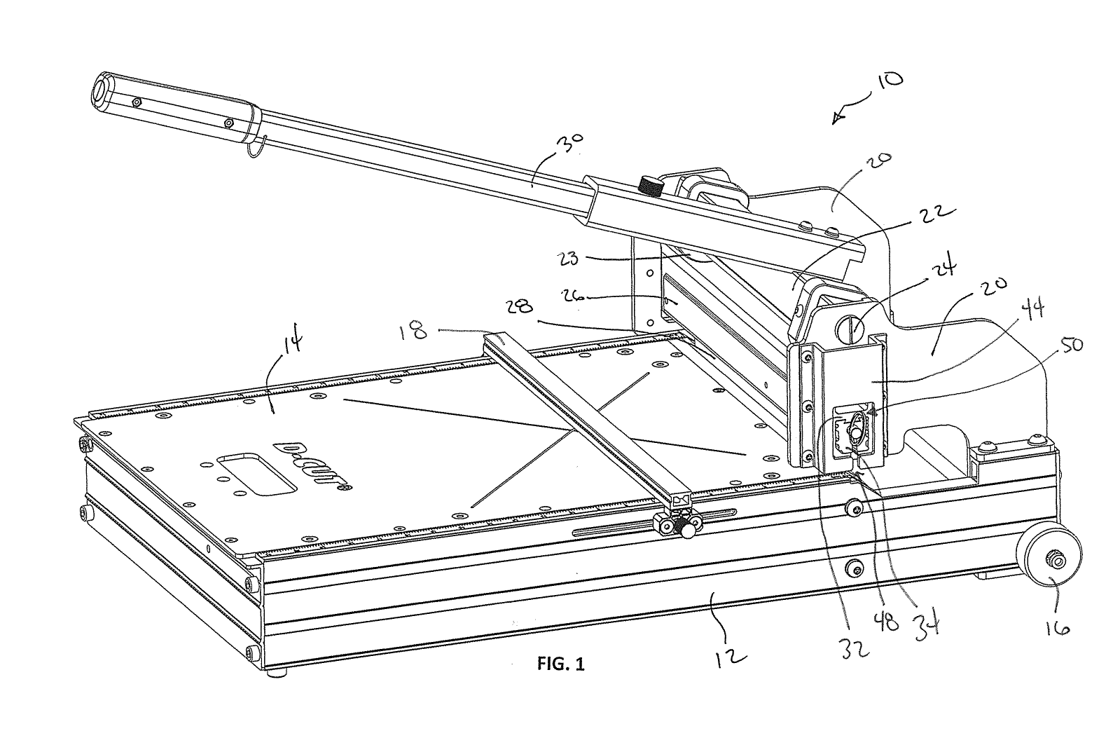

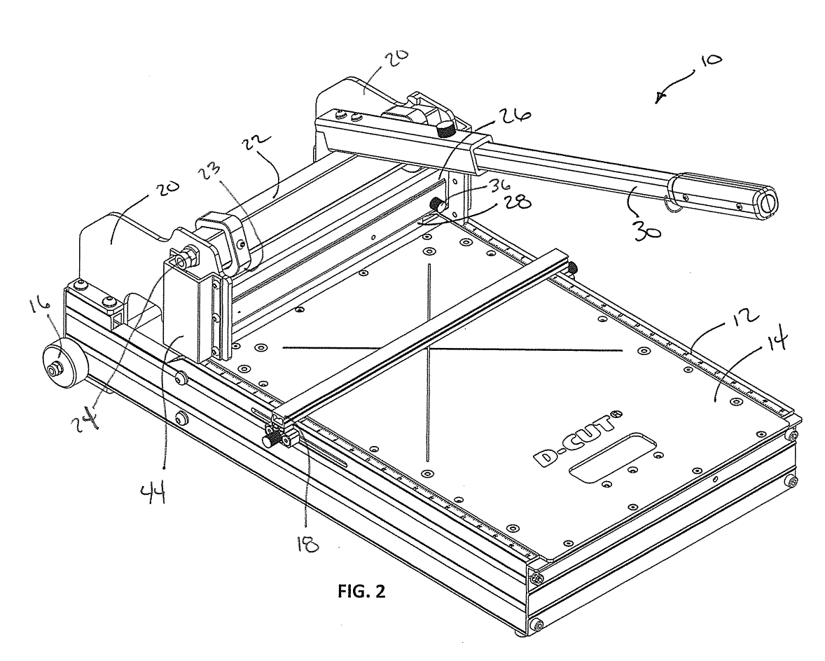

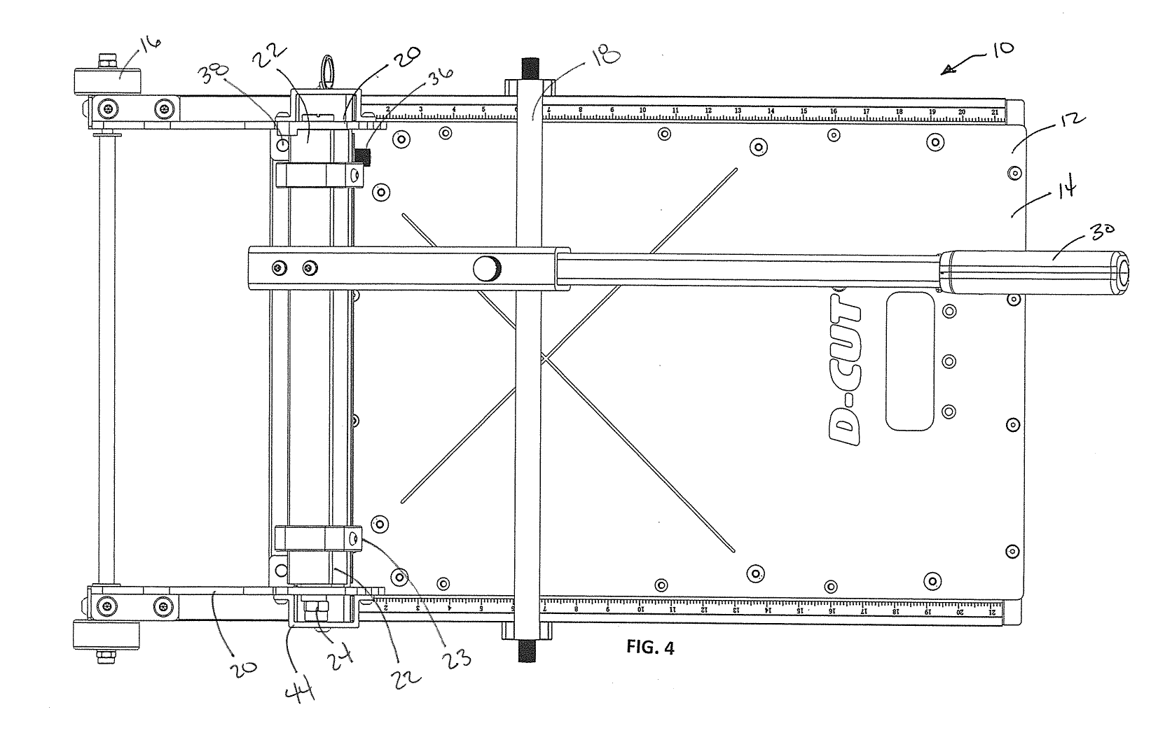

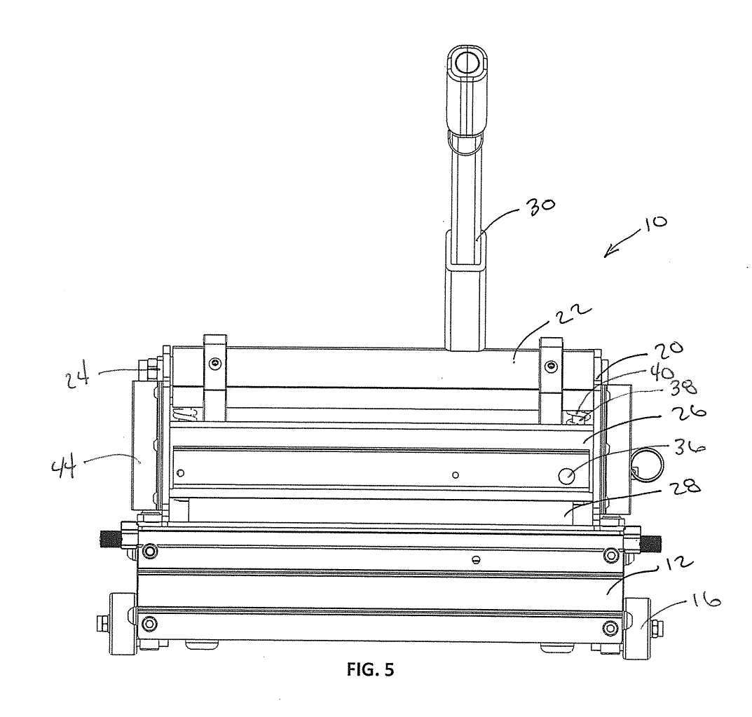

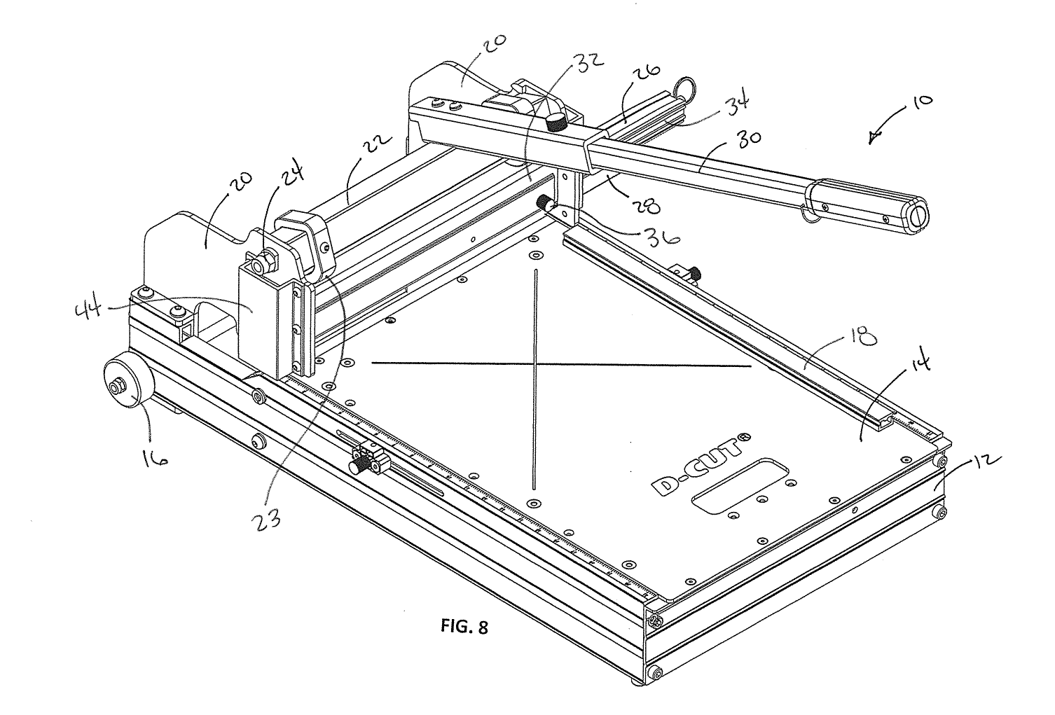

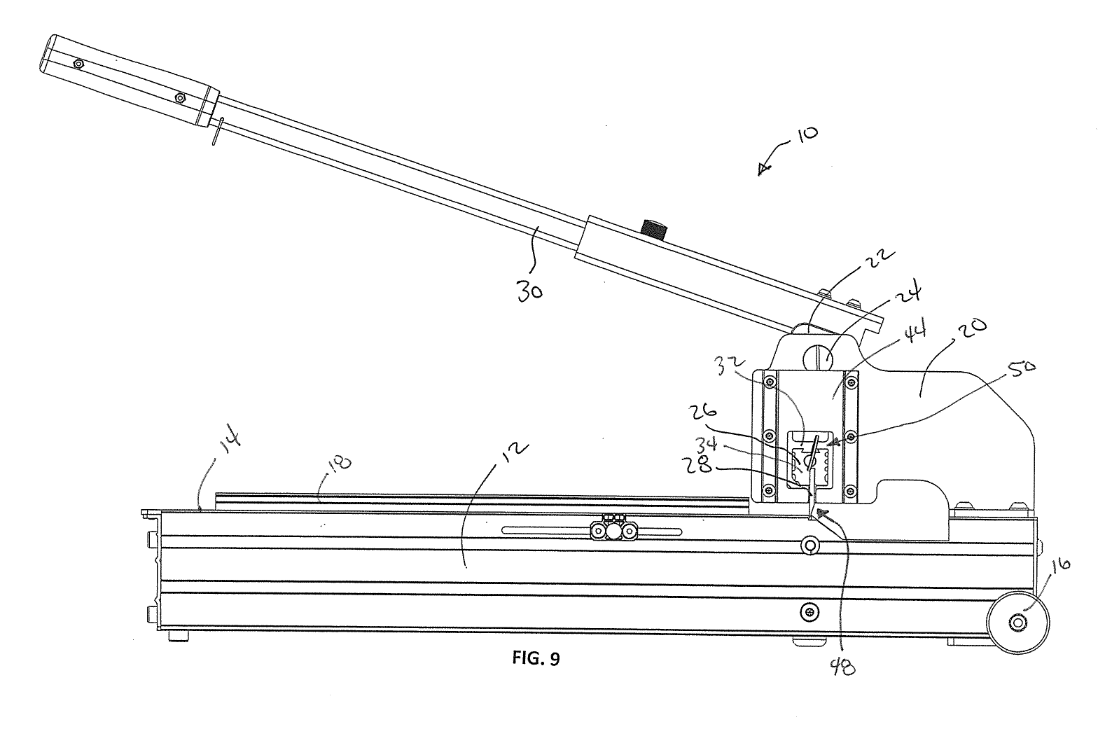

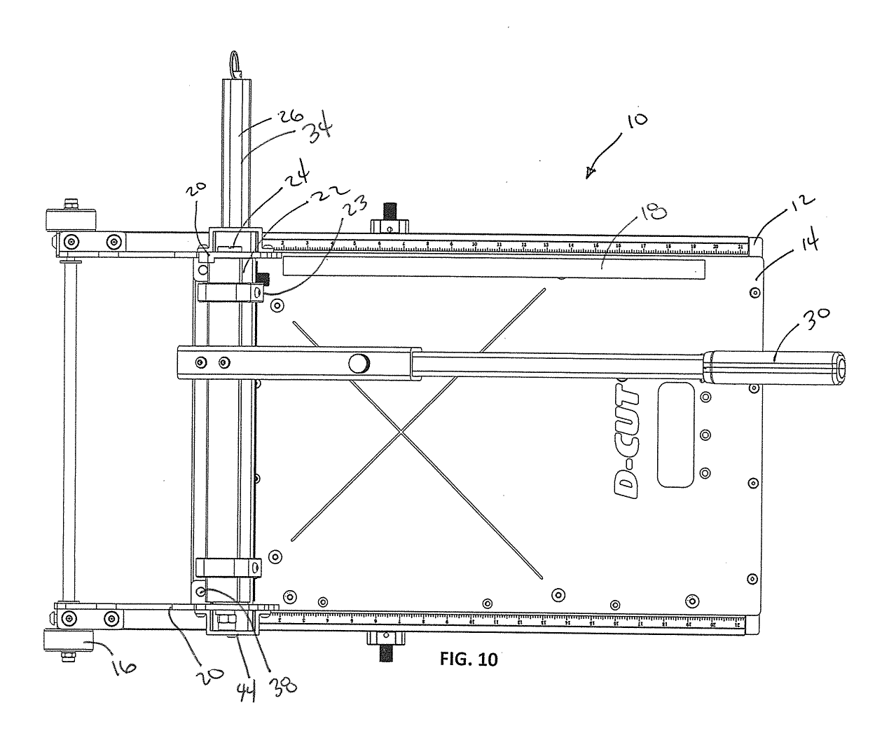

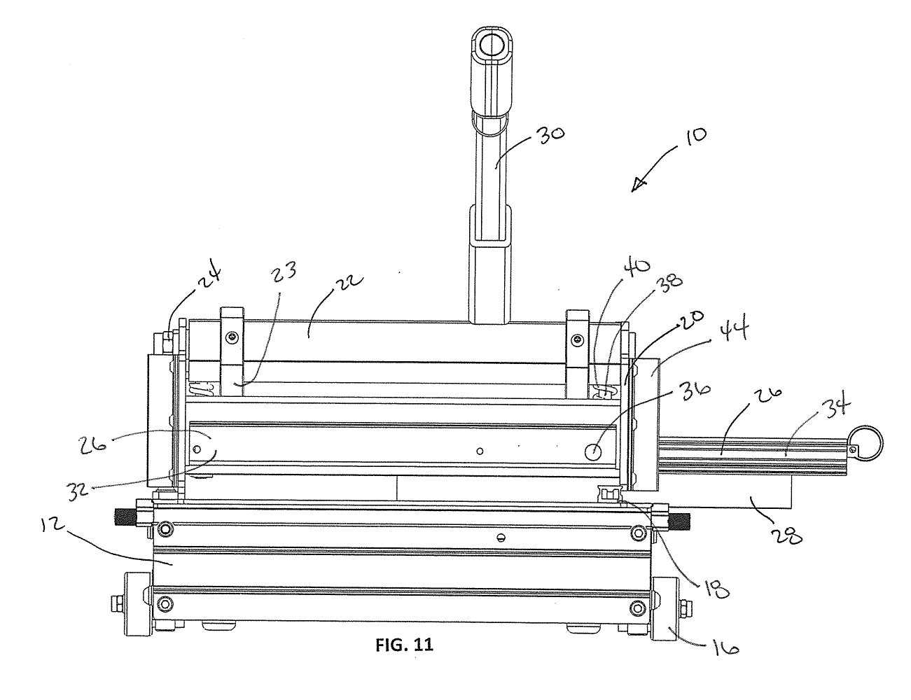

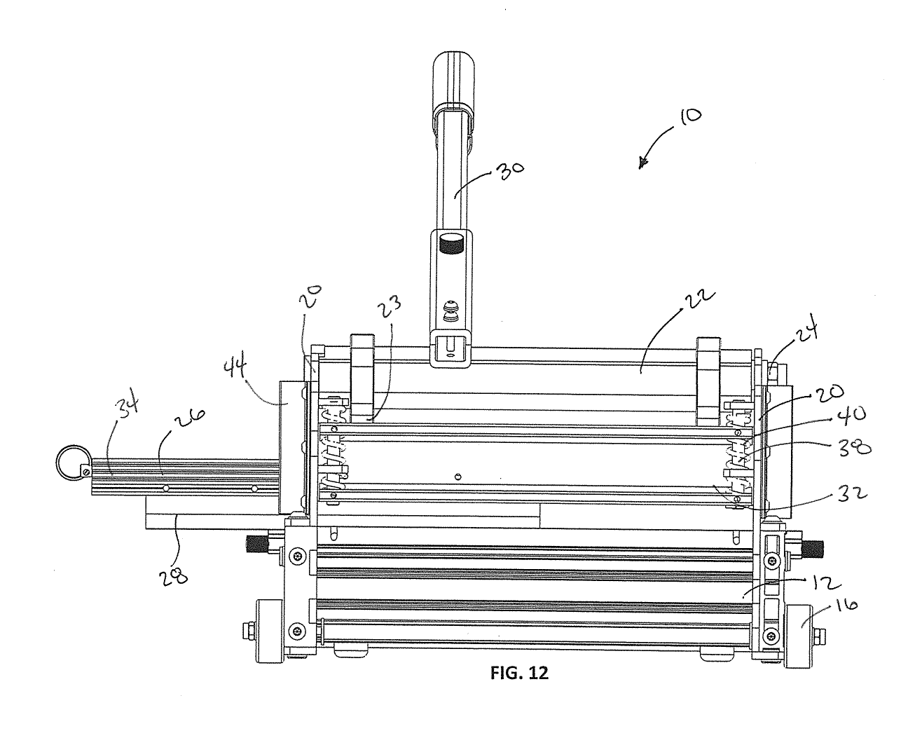

FIGS. 1-12 show a cutting tool 10 according to one embodiment of this invention. The cutting tool 10 as described is preferably used to cut building materials in a predictable and straight fashion without splintering, cracking or similar problems that may arise from such cuts.

As used herein, “material” refers to a sheet or plank of building material, preferably flooring, such as wood flooring, laminate flooring, composite flooring, vinyl flooring, wood plastic composite (WPC), luxury vinyl plank (LVP), vinyl composition tile (VCT), or similar materials, including, but not limited to, one or more combinations of wood, fiber, concrete, plastic and/or other materials that may or may not include a laminated layer.

As shown in FIGS. 1-12, the cutting tool 10 includes a base 12. In this embodiment, the base 12 comprises a rectangular shape that provides stability for the cutting tool 1o. However, the base 12 is not limited to this shape and may be manufactured in any shape that provide support for the material to be cut. The base 12 is preferably formed of steel or similar rigid material that is capable of withstanding forces generated in cutting the materials. The base 10 is preferably sized to accommodate standard sizes of material, such as flooring, and may correspond in width to such flooring. In an embodiment of this invention, the base 12 provides a 13 inch cutting width. However, cutting tool 10 is not limited to this cutting width and may be designed with other dimensions.

The base 12 preferably includes a support surface 14 for accommodating the flooring material to be cut. In an embodiment of the invention, the support surface 14 preferably includes a textured or a high friction, non-slip surface that prevents the material from slipping or moving during cutting process. The support surface 14 is preferably made of lightweight and durable materials, such as plastic, rubber, metal and/or composite materials, but may be made of any material capable of supporting the building materials and withstanding the cutting force. The support surface 14 preferably corresponds in size with the base 12 is also preferably sized to accommodate standard sizes of materials and may correspond in width to such materials.

The base 12 preferably further includes a pair of wheels 16 and a pull handle to make it easy to move the cutting tool 10. The base 12 may further include one or more support members, such as foot, providing stability to the cutting tool 10 before and during the cutting process. In a preferred embodiment, the support members may be adjustable to compensate for an uneven ground surface and to maintain a level support surface.

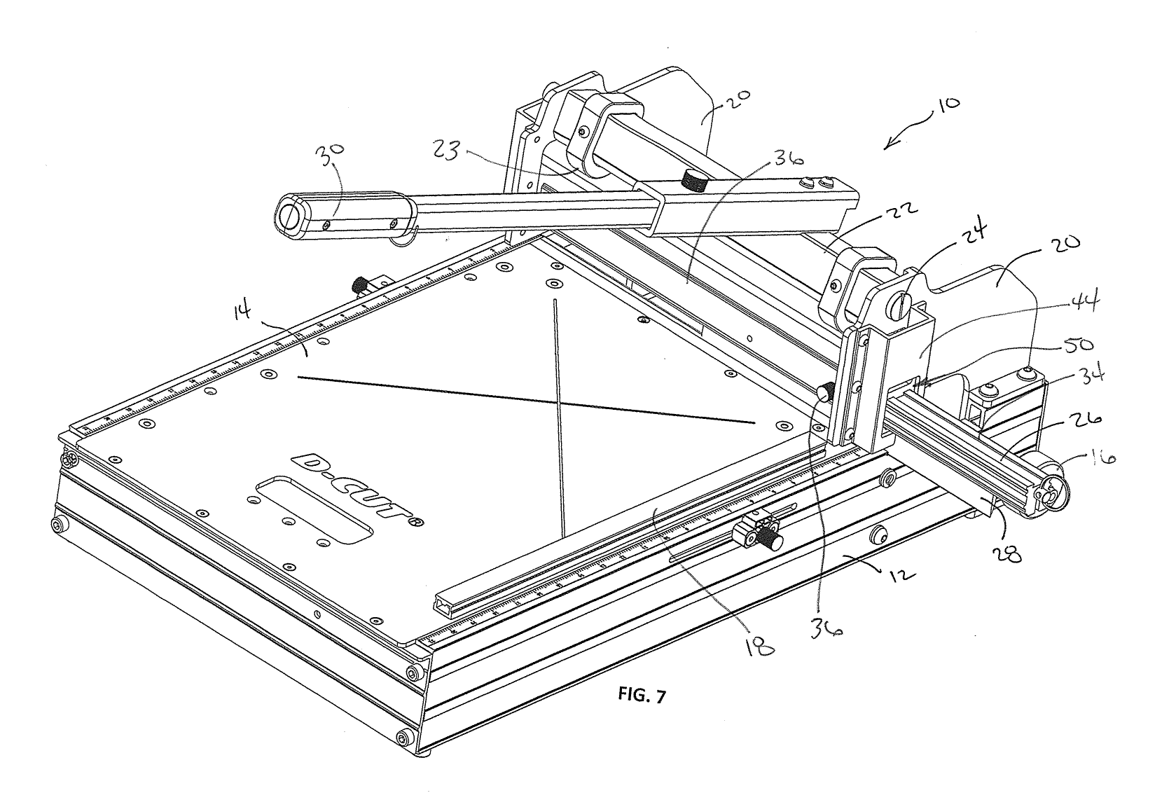

In a preferred embodiment, the cutting tool 10 further includes a guide rail 18 that can be used to align the material to the blade 20. In the embodiment of FIGS. 1-6, the guide rail 18 is connected to a lockable, slider positioned on either side of the base 12. In this embodiment, the guide rail 18 can be set parallel to a cutting plane of a blade. This position of the guide rail allows for the material to be positioned between a portion of the supports and the guide rail for making length wise cuts in the material. In the embodiment of FIGS. 1-12, the support surface 14 further includes a plurality of apertures for connecting the guide rail 18 to the support surface 14 at a plurality of angles to the cutting plane of the blade including, but not limited to a right angle and a 45° angle. As shown in FIG. 7, the guide rail 18 is set at a 90° angle to the cutting plane of the blade. The guide rail 18 may further include a ruler for measuring the material to be cut.

As shown in the figures, a pair of supports 20 are connected to the base 12, each support is positioned on each side of the base. In this embodiment, the pair of supports each comprise an L-shape and extend generally perpendicular to a plane of the support surface 14. The L-shape provides cantilevered support of cutting elements, allowing the cutting elements to be offset from the connection point of each support 20 to the base 14. This design allows the material to be cut to pass under a portion of the supports 20 in proximity to the blade for lengthwise cuts and notch cuts. However, the supports need not comprise an L-shape and may be design with another shape that may or may not provide an offset. The pair of supports 20 are preferably formed of materials such as steel or another rigid material that is capable of withstanding the force needed to cut materials.

As shown in the figures, a cam 22 is positioned between the pair of supports 20 and over a portion of the base 12. The cam 22 preferably includes a cam axle 24 that extends through a portion of each of the pair of supports 20 to rotatably connect the cam 22 to the pair of supports 20. The cam 22 further includes a cammed edge 23 with at least two radii and preferably with a gradually increasing radius.

In a preferred embodiment, this invention includes a handle 30 with a proximate end and a distal end. The proximate end of the handle 30 is attached to the cam 22, to provide leverage to a user to rotate the cam 22. This attachment can be formed in various ways including, but not limited to, a threaded connection, a welded connection or by integrating the cam 22 and the handle 30. The distal end preferably includes a hand grip or other portion for the user to manually grab or engage. In a preferred embodiment, the handle 30 may be extendible to provide a longer lever for cutting the material. In the figures, the handle comprises a pair of nested square-tubular structures which can be extended by sliding an inner structure out from an outer structure thereby increasing leverage for the user. However, other designs for extending the handle to increase leverage may be used.

In a preferred embodiment, a blade holder 26 and a blade 28 are positioned between at least a portion of the cam 22 and a portion of the base 12. The blade holder 26 may be formed of a material such as steel or similar rigid material. The blade 28 is preferably formed of a tungsten steel capable of repeatedly cutting all thicknesses and compositions of material. In an embodiment of this invention, the blade 28 comprises a 13 inch width and a 10 mm depth. However, it should be understood that the blade is not limited to these dimensions and may be designed with any dimensions required for an application. The blade 28 preferably extends transversely relative to the base 12, that is, perpendicular to the lengthwise dimension of the base 12. Actuation of the handle 30 preferably lowers and raises the blade holder 26 and the blade 28 from an open position to a closed position.

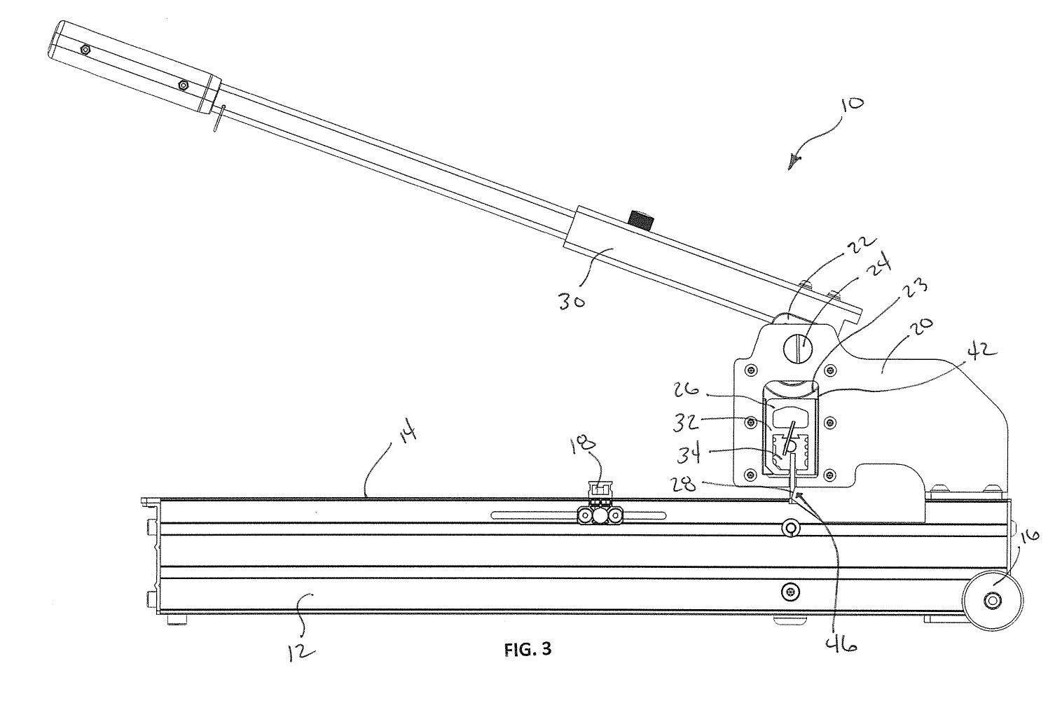

As best shown in FIG. 3, with a side cover 44 removed from the support 20, each support 20 includes an alignment aperture 42. In this embodiment, a portion of the blade holder 26 is positioned within the alignment aperture limiting movement of the blade holder to a linear motion. Preferably, the alignment aperture has a width that is only slightly larger that a width of the blade holder 26 and a height that is longer that a height of the blade holder 26. This design restricts the movement of the blade holder 26 to a generally linear up and down motion with no or minimal sideways movement, thereby providing a generally straight cut. For example, in one embodiment, the width of the alignment aperture 42 is 1 mm larger than the width of the blade holder 26 and the height of the alignment aperture 42 is 10 mm larger than the height of the blade holder 26. However, it should be understood that the dimensions of the alignment aperture and the blade holder are not limited to these respective dimensions and a tolerance between the alignment aperture and the blade holder may be reduced or increased. As best shown in FIG. 3, the support 20 further includes a slot 46, which allows the blade 28 to pass through. As best shown in FIG. 1, the side cover 44 also includes a slot 48, which allows the blade to pass through.

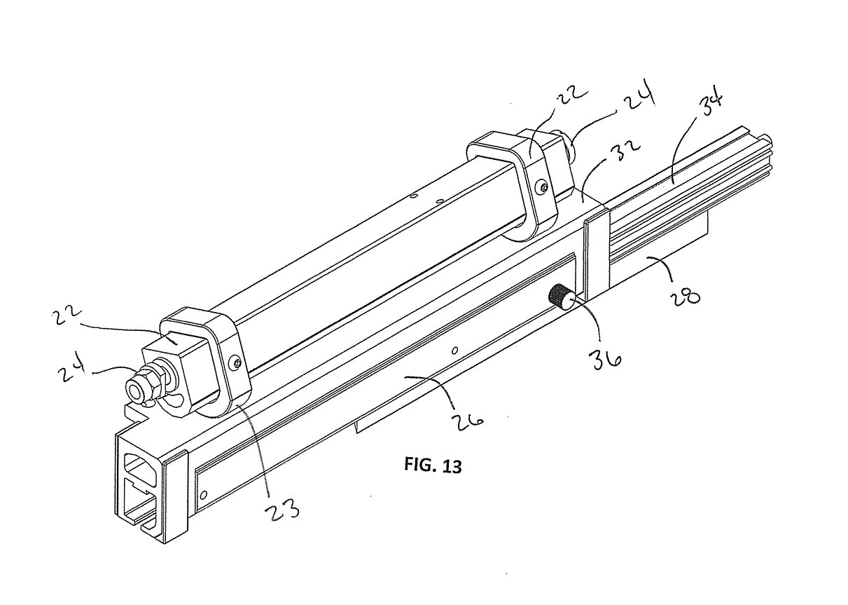

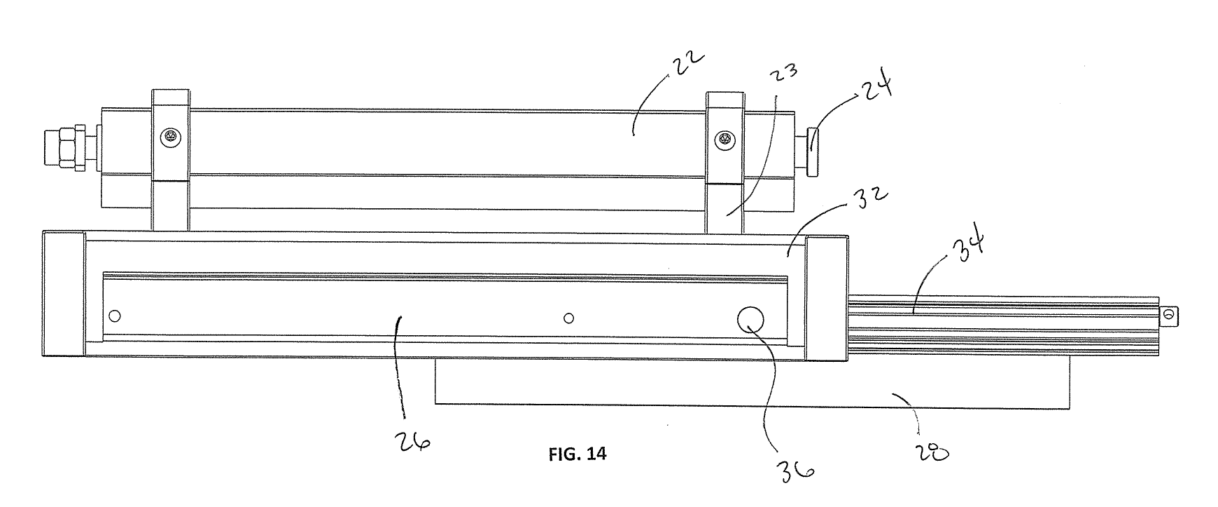

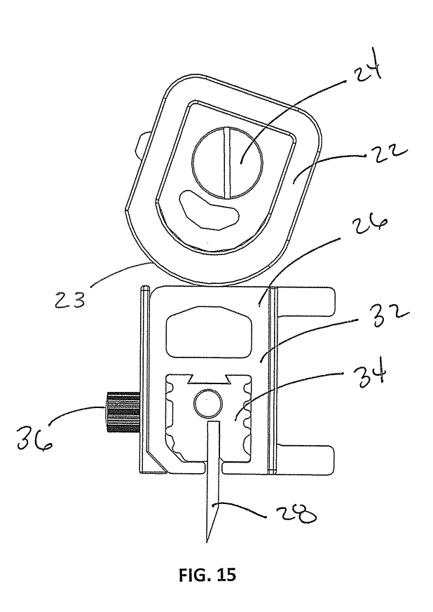

In a preferred embodiment of this invention, the blade holder 26 and the blade 28 are movable relative to the pair of supports 20 allowing the blade 28 to be positioned either wholly between the pair of supports 20 or with a portion of the blade 26 between the supports 20 and a portion of the blade 26 outside one of the supports. This slideable arrangement allows a user to either cut an entire width of material positioned between the supports or a portion of the width of the material positioned between the supports. For example, in FIGS. 1-6, the blade holder 26 and the blade 28 are positioned between the pair of supports 20. In FIGS. 7-12, a portion of the blade holder 26 and the blade 28 remains between the pair of supports 20, while another portion of the blade holder 26 and the blade 28 is positioned outside of one of the supports 20 allowing for only the portion of the blade 28 positioned between the supports 20 to cut a material. This slideable arrangement may be useful for cutting notches or other shapes into the flooring material. FIGS. 13-15 show an embodiment of the blade holder 26 with the slideable blade 28 according to an embodiment of this invention. In this embodiment, the blade holder 26 comprises a blade holder frame 32 and a blade holder beam 34 that slides within the blade holder frame 32. As best shown in FIG. 3, at least one of the pair of supports 20 includes the alignment aperture 42 and the slot 46 to allow the blade holder beam 34 and the blade 28 to pass through. As best shown in FIG. 1, the side cover 44 also includes an opening 50 and the slot 48 to allow the blade holder beam 34 and the blade 28 to pass through. In a preferred embodiment, the blade holder 26 includes a lock 36 for temporarily securing a position of the blade holder beam 34 and the blade 28 relative to the blade holder frame 32. In the embodiment shown in FIGS. 13-15, the lock 36 comprises a threaded connector in the blade holder frame 32 which can be turned to press against the blade holder beam 34 which in turn is pressed against an inner wall of the blade holder frame 32 to fix the position of the blade holder beam 34 relative to the blade holder 32 and securing the blade 28 in a desired position relative to at least one of the supports 20. This threaded connector allows the blade holder beam 34 to be repeatably, temporarily set in position relative to the blade holder frame 32. However, the lock 36 is not limited to this mechanism and may comprise other known methods for securing a position of the blade holder beam 34 and the blade 20.

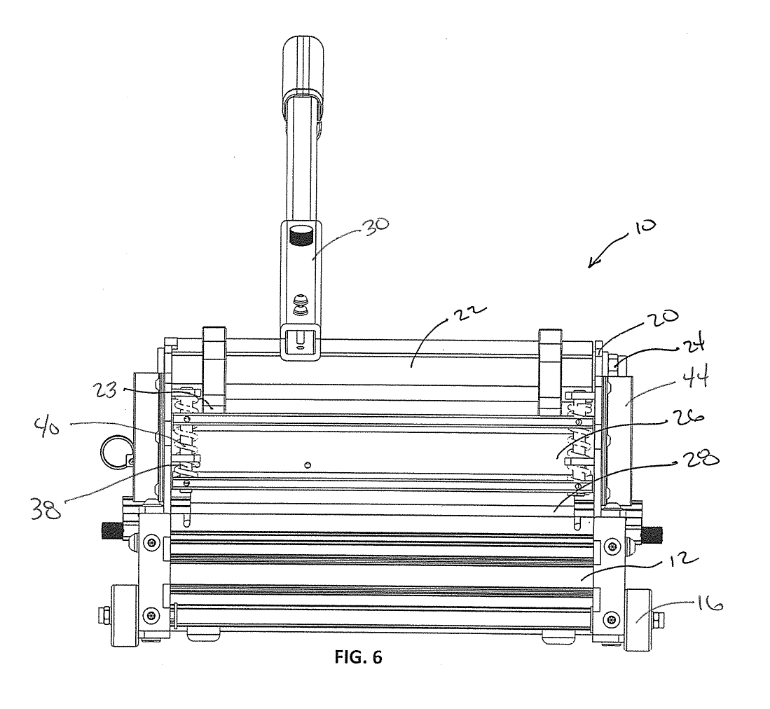

In an embodiment of this invention, the cutting tool 10 includes one or more guide pillars 38 to maintain a generally straight path as the blade holder 26 moves from the open position to the closed position. As shown in FIG. 6, the guide pillar 38 is mounted to the support 20. As shown, the blade holder 26 includes an alignment tab that surrounds the guide pillar 38 restricting movement of the blade holder 26 to a generally linear motion. This preferred embodiment provides a straight cut and resists lateral movement of the blade making the invention is less prone to binding during cutting.

According to a preferred embodiment, the cutting tool 10 is biased upward into the open position by a spring 40. In the embodiment shown, the spring 40 wraps around the guide pillar 38. In an alternative embodiment, the spring 40 may or may not wrap around the guide pillar 38.

In operation, the cutting tool 10 of this invention starts in the open position with the cam 22 contacting the blade holder 26 at a relatively small radius, this provides an opening between the blade 28 and a blade stop of the base. A user inserts the flooring material to be cut onto the support surface 14 of the base 10 and through the opening formed between the blade 28 and the base 12. To cut the material, the handle 30 is lowered to rotate the cam 22. By rotating the cam 22, a gradually increasing radius of the cam 22 contacts the blade holder 26 thereby forcing the blade 28 downward and through the material. The resulting cut is optimally free of splinters and a resulting cut end of the material is otherwise clean and straight.

While in the foregoing specification this invention has been described in relation to certain preferred embodiments thereof, and many details have been set forth for purpose of illustration, it will be apparent to those skilled in the art that the material cutter is susceptible to additional embodiments and that certain of the details described herein can be varied considerably without departing from the basic principles of the invention.

What is claimed is:

1. A cutting tool for cutting materials, the cutting tool comprising:
a base including a support surface;
a pair of supports connected to the base;
a cam rotatably connected to the pair of supports with an axle; and
a blade holder with a blade positioned at least partially between the cam and the base, wherein the blade holder and the blade are movable between an open position and a closed position by pivoting the cam and wherein the blade holder and blade slides generally perpendicularly relative to the base and relative to the supports allowing the blade to be positioned either wholly between the pair of supports or with a portion of the blade between the pair of supports.

2. The cutting tool of claim 1, wherein each of the pair of supports are L-shaped providing a gap between a portion of the support and the base.

3. The cutting tool of claim 1, wherein the blade holder comprises a blade holder frame and a blade holder beam and wherein the blade holder beam slides relative to the blade holder frame.

4. The cutting tool of claim 3, wherein the blade holder includes a lock to temporarily fix a position of the blade beam relative to the blade holder frame.

5. The cutting tool of claim 4, wherein the lock comprises a threaded connector in the blade holder frame which engages the blade holder beam to fix the position of the blade holder beam relative to the blade holder frame.

6. The cutting tool of claim 1, further comprising a handle connected to the cam, wherein the handle provides leverage to rotate the cam about the axle.

7. The cutting tool of claim 1, further comprising a guide pillar connected to one of the supports, wherein the blade holder includes an alignment tab which surrounds the guide pillar restricting movement of the blade holder to a generally linear motion along the guide pillar.

8. The cutting tool of claim 7, further including a spring to bias the blade holder to the open position.

9. The cutting tool of claim 1, further including a guide rail connected to at least one of the base or the support surface.

10. A cutting tool comprising:
a base;
a pair of supports extending from sides of the base, wherein at least one of the pair of supports includes an alignment aperture;
a cam rotatably connected to the pair of supports; and
a blade holder positioned under the cam and with a portion of the blade holder positioned within the alignment aperture, wherein the blade holder includes a blade holder frame with a blade holder beam slideable relative to the blade holder frame;
a blade connected to the blade holder; wherein the blade holder and the blade are movable between an open position and a closed position by rotating the cam; and
wherein the blade holder beam slides relative to the blade holder frame allowing the blade to be positioned either wholly between the pair of supports or with a portion of the blade between the pair of supports.

11. The cutting tool of claim 10, wherein the pair of supports are cantilevered providing a gap between an end of the support and the base.

12. The cutting tool of claim 10, wherein the blade holder includes a lock to temporarily secure a position of the blade holder beam relative to the blade holder frame.

13. The cutting tool of claim 10, wherein the lock comprises a threaded connector in the blade holder frame which engages the blade holder beam to fix the position of the blade holder beam relative to the blade holder frame.

14. The cutting tool of claim 10, further comprising a handle connected to the cam, wherein the handle provides leverage to rotate the cam about the axle.

15. The cutting tool of claim 10, further comprising a guide pillar connected to one of the supports, wherein the blade holder includes an alignment tab which surrounds the guide pillar restricting movement of the blade holder to a generally linear motion along the guide pillar.

16. The cutting tool of claim 15, further including a spring to bias the blade holder to the open position.

17. The cutting tool of claim 10, wherein the base includes a support surface to support a material to be cut.

18. The cutting tool of claim 17, further including a guide rail connected to at least one of the base and the support surface.

19. The cutting tool of claim 18, wherein the guide rail is repositionable on the cutting tool in a plurality of positions including perpendicular to a cutting plane, parallel to the cutting plane and at an angle to the cutting plane.
